(19) United States
(12) Patent Application Publication
(10) Pub. No.: US 2018/0048987 A1
(43) Pub. Date: Feb. 15, 2018

(54) UPDATING FIRMWARE AND/OR PERFORMING A DIAGNOSTIC CHECK ON AN INTERNET OF THINGS DEVICE WHILE PROVIDING WIRELESS POWER VIA A MAGNETIC COUPLING AND SUPPORTING A TWO-WAY WIRELESS POWER EXCHANGE CAPABILITY AT A DEVICE

(71) Applicant: QUALCOMM Incorporated, San Diego, CA (US)

(72) Inventor: Paul John MORRIS, Cambridge (GB)

(21) Appl. No.: 15/237,465

(22) Filed: Aug. 15, 2016

(51) Int. Cl. H04W 4/00; H04B 5/00; H04L 29/08

(52) U.S. Cl. CPC H04W 4/008; H04L 67/10; H04B 5/0037; H04W 84/12

(57) ABSTRACT

In an embodiment, a control device transmits wireless power to an IoT device via a magnetic coupling between at least one antenna of the IoT device and a magnetic field that is generated by the control device. The IoT device powers a short-range wireless communications interface at the IoT device using some or all of the wireless power, which is then used to transfer a firmware update for the IoT device and/or exchange diagnostic information. In another embodiment, a dual-mode wireless power transfer device includes dual-mode wireless power transceiver circuitry that permits operation in a receive-power mode or a transmit-power mode. Wireless power is transmitted by the dual-mode wireless power transfer device in the transmit-power mode, and wireless power is received by the dual-mode wireless power transfer device in the receive-power mode.

### TECHNICAL FIELD

Embodiments described herein generally relate to updating firmware and/or performing a diagnostic check on an Internet of Things (IoT) device while providing wireless power via a magnetic coupling and supporting a two-way wireless power exchange capability at a device.

### BACKGROUND

The Internet is a global system of interconnected computers and computer networks that use a standard Internet protocol suite (e.g., the Transmission Control Protocol (TCP) and Internet Protocol (IP)) to communicate with each other. The Internet of Things (IoT) is based on the idea that everyday objects, not just computers and computer networks, can be readable, recognizable, locatable, addressable, and controllable via an IoT communications network (e.g., an ad-hoc system or the Internet).

A number of market trends are driving development of IoT devices. For example, increasing energy costs are driving governments' strategic investments in smart grids and support for future consumption, such as for electric vehicles and public charging stations. Increasing health care costs and aging populations are driving development for remote/connected health care and fitness services. A technological revolution in the home is driving development for new “smart” services, including consolidation by service providers marketing ‘N’ play (e.g., data, voice, video, security, energy management, etc.) and expanding home networks. Buildings are getting smarter and more convenient as a means to reduce operational costs for enterprise facilities.

There are a number of key applications for the IoT. For example, in the area of smart grids and energy management, utility companies can optimize delivery of energy to homes and businesses while customers can better manage energy usage. In the area of home and building automation, smart homes and buildings can have centralized control over virtually any device or system in the home or office, from appliances to plug-in electric vehicle (PEV) security systems. In the field of asset tracking, enterprises, hospitals, factories, and other large organizations can accurately track the locations of high-value equipment, patients, vehicles, and so on. In the area of health and wellness, doctors can remotely monitor patients' health while people can track the progress of fitness routines.

As such, in the near future, increasing development in IoT technologies will lead to numerous IoT devices surrounding a user at home, in vehicles, at work, and many other locations. Due at least in part to the potentially large number of heterogeneous IoT devices and other physical objects that may be in use within a controlled IoT network, which may interact with one another and/or be used in many different ways, well-defined and reliable communication interfaces are generally needed to connect the various heterogeneous IoT devices such that the various heterogeneous IoT devices can be appropriately configured, managed, and communicate with one another to exchange information.

Certain IoT devices are deployed with firmware that controls general device functions and which changes infrequently. However, there are times when firmware updates are required for various reasons, such as enabling new features, fixing bugs in older firmware versions, maintaining compatibility with various communication protocols or other standards, improving various efficiencies of operation (e.g., improving a heart-rate monitor algorithm, etc.), assigning new security patches or updating a network key, and so on. These IoT devices can remain in active communication with the IoT network to check for firmware updates, but this can be a power-consuming process (particularly for battery-powered IoT devices) and the IoT communications interface used by the IoT network may not be sufficiently secure for transferring a firmware update. An alternative to using the IoT network to update the firmware on an IoT device is for a user to manually update the firmware via direct interaction with the IoT device, but manually installing firmware updates may be tedious and may not be possible for IoT devices installed in hard to reach locations (e.g., behind walls, etc.). Collecting diagnostic information from IoT devices can also be a power-consuming process, and manually collecting such diagnostic information may be difficult for IoT devices installed in hard to reach locations.

### SUMMARY

In an embodiment, a control device transmits wireless power to an IoT device via a magnetic coupling between at least one antenna of the IoT device and a magnetic field that is generated by the control device. The IoT device powers a short-range wireless communications interface at the IoT device using some or all of the wireless power. The control device communicates to transfer a firmware update for the IoT device and/or exchange diagnostic information, after which the IoT device installs the firmware update. In another embodiment, a dual-mode wireless power transfer device includes dual-mode wireless power transceiver circuitry that permits operation in a receive-power mode or a transmit-power mode. Wireless power is transmitted by the dual-mode wireless power transfer device in the transmit-power mode, and wireless power is received by the dual-mode wireless power transfer device in the receive-power mode.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIGS. 1A-1E illustrate exemplary high-level system architectures of wireless communications systems that may include various Internet of Things (IoT) devices, according to various aspects.

FIG. 2A illustrates an exemplary IoT device and FIG. 2B illustrates an exemplary passive IoT device, according to various aspects.

FIG. 3 illustrates a communication device that includes various structural components configured to perform functionality, according to various aspects.

FIG. 4 illustrates a control device that is magnetically coupled to an IoT device in accordance with an embodiment of the disclosure.

FIG. 5 illustrates an antenna configuration at the control device of FIG. 4 in accordance with an embodiment of the disclosure.

FIG. 6 illustrates an antenna configuration at the IoT device of FIG. 4 in accordance with an embodiment of the disclosure.

FIG. 7 illustrates a Near Ultra-Low Energy Field power exchange system whereby power is exchanged between two coils in accordance with an embodiment of the disclosure.

FIG. 8 illustrates operation of a control device in accordance with an embodiment of the disclosure.

FIG. 9 illustrates operation of an IoT device in accordance with an embodiment of the disclosure.

FIG. 10 illustrates an example implementation of the processes of FIGS. 8-9 in accordance with an embodiment of the disclosure.

FIG. 11 illustrates a dual-mode wireless power transfer device that is configured to connect to a power transmitting device and a power receiving device in accordance with an embodiment of the disclosure.

FIG. 12 illustrates an antenna configuration at the dual-mode wireless power transfer device in accordance with an embodiment of the disclosure.

FIG. 13 illustrates a process whereby the dual-mode wireless power transfer device switches between the receive-power mode and the transmit-power mode in accordance with an embodiment of the disclosure.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the term “Internet of Things device” (or “IoT device”) may refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

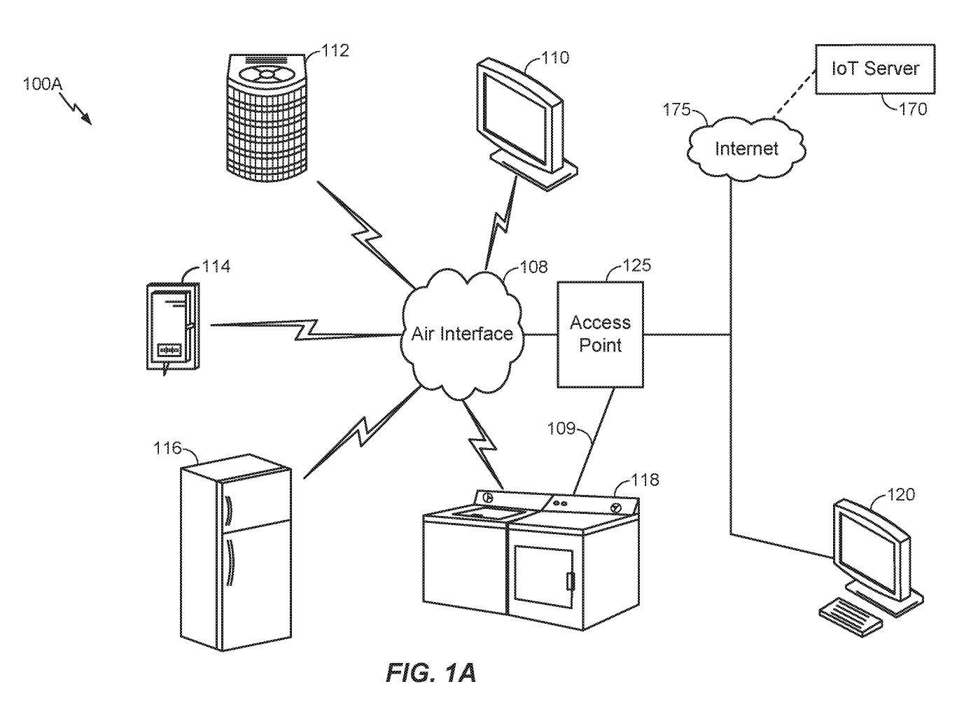

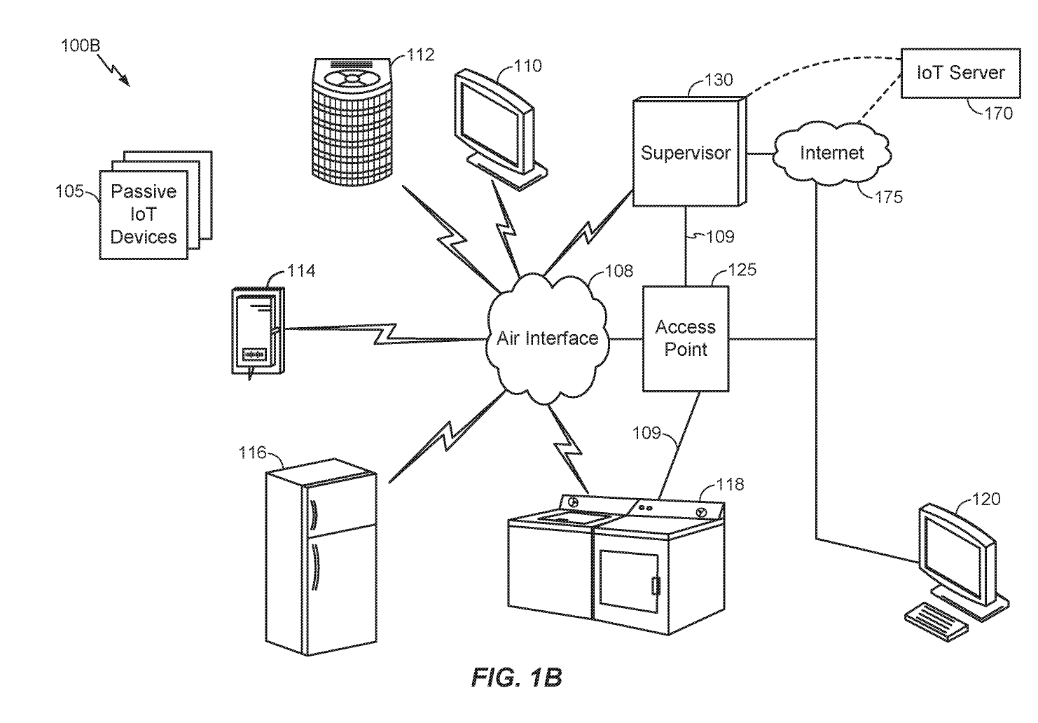

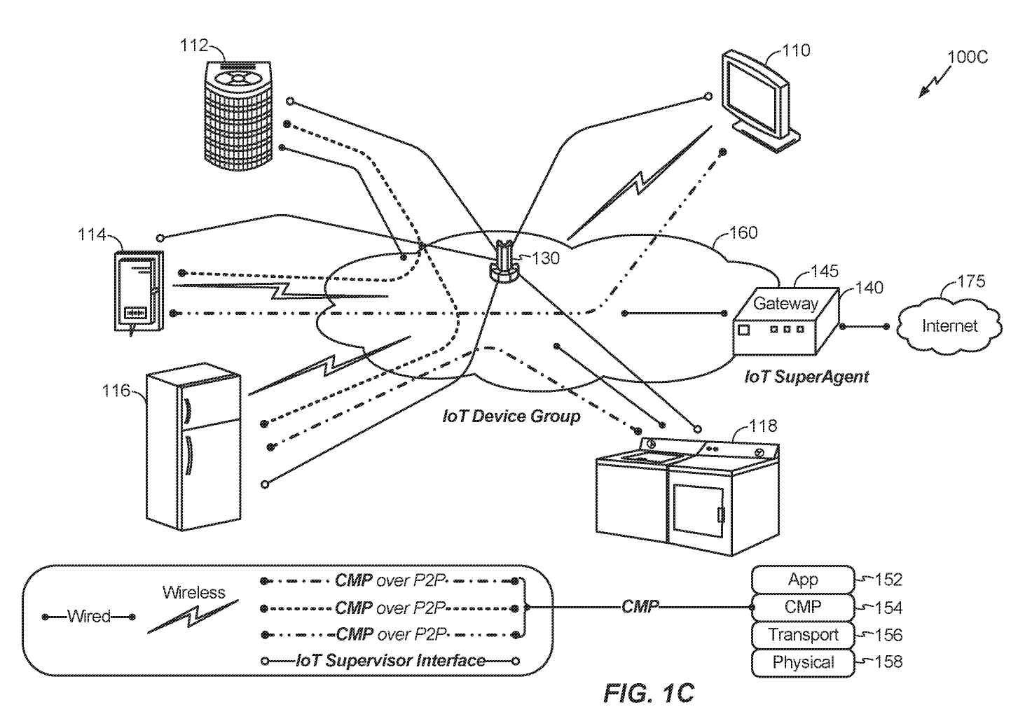

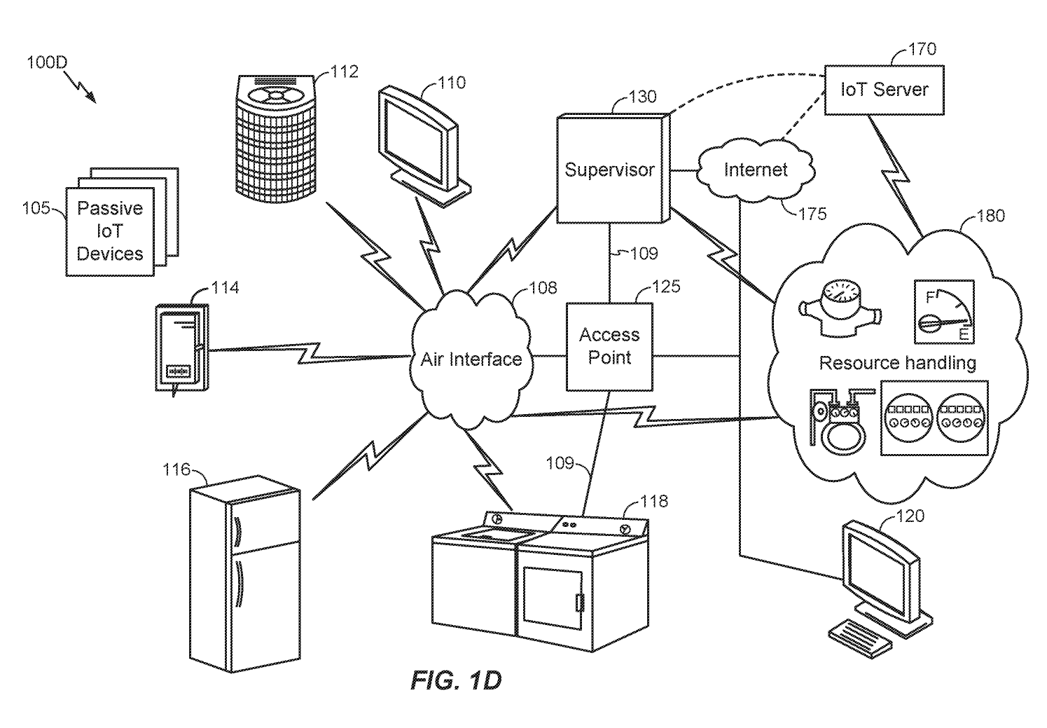

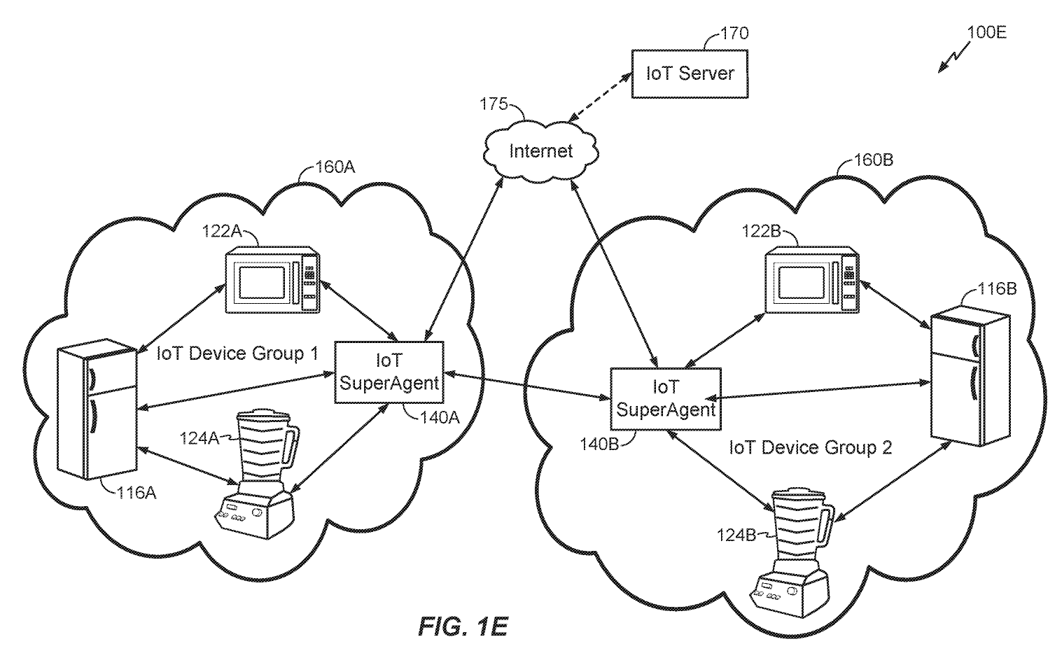

FIG. 1A illustrates a high-level system architecture of a wireless communications system 100A in accordance with various aspects. The wireless communications system 100A contains a plurality of IoT devices, which include a television 110, an outdoor air conditioning unit 112, a thermostat 114, a refrigerator 116, and a washer and dryer 118.

Referring to FIG. 1A, IoT devices 110-118 are configured to communicate with an access network (e.g., an access point 125) over a physical communications interface or layer, shown in FIG. 1A as air interface 108 and a direct wired connection 109. The air interface 108 can comply with a wireless Internet protocol (IP), such as IEEE 802.11. Although FIG. 1A illustrates IoT devices 110-118 communicating over the air interface 108 and IoT device 118 communicating over the direct wired connection 109, each IoT device may communicate over a wired or wireless connection, or both.

The Internet 175 includes a number of routing agents and processing agents (not shown in FIG. 1A for the sake of convenience). The Internet 175 is a global system of interconnected computers and computer networks that uses a standard Internet protocol suite (e.g., the Transmission Control Protocol (TCP) and IP) to communicate among disparate devices/networks. TCP/IP provides end-to-end connectivity specifying how data should be formatted, addressed, transmitted, routed and received at the destination.

In FIG. 1A, a computer 120, such as a desktop or personal computer (PC), is shown as connecting to the Internet 175 directly (e.g., over an Ethernet connection or Wi-Fi or 802.11-based network). The computer 120 may have a wired connection to the Internet 175, such as a direct connection to a modem or router, which, in an example, can correspond to the access point 125 (e.g., for a Wi-Fi router with both wired and wireless connectivity). Alternatively, rather than being connected to the access point 125 and the Internet 175 over a wired connection, the computer 120 may be connected to the access point 125 over air interface 108 or another wireless interface, and access the Internet 175 over the air interface 108. Although illustrated as a desktop computer, computer 120 may be a laptop computer, a tablet computer, a PDA, a smart phone, or the like. The computer 120 may be an IoT device and/or contain functionality to manage an IoT network/group, such as the network/group of IoT devices 110-118.

The access point 125 may be connected to the Internet 175 via, for example, an optical communication system, such as FiOS, a cable modem, a digital subscriber line (DSL) modem, or the like. The access point 125 may communicate with IoT devices 110-120 and the Internet 175 using the standard Internet protocols (e.g., TCP/IP).

Referring to FIG. 1A, an IoT server 170 is shown as connected to the Internet 175. The IoT server 170 can be implemented as a plurality of structurally separate servers, or alternately may correspond to a single server. In various embodiments, the IoT server 170 may be optional (as indicated by the dotted line), and the group of IoT devices 110-120 may be a peer-to-peer (P2P) network. In such a case, the IoT devices 110-120 can communicate with each other directly over the air interface 108 and/or the direct wired connection 109 using appropriate device-to-device (D2D) communication technology. Alternatively, or additionally, some or all of the IoT devices 110-120 may be configured with a communication interface independent of the air interface 108 and the direct wired connection 109. For example, if the air interface 108 corresponds to a Wi-Fi interface, one or more of the IoT devices 110-120 may have Bluetooth or NFC interfaces for communicating directly with each other or other Bluetooth or NFC-enabled devices.

In a peer-to-peer network, service discovery schemes can multicast the presence of nodes, their capabilities, and group membership. The peer-to-peer devices can establish associations and subsequent interactions based on this information.

In accordance with various aspects, FIG. 1B illustrates a high-level architecture of another wireless communications system 100B that contains a plurality of IoT devices. In general, the wireless communications system 100B shown in FIG. 1B may include various components that are the same and/or substantially similar to the wireless communications system 100A shown in FIG. 1A, which was described in greater detail above (e.g., various IoT devices, including a television 110, outdoor air conditioning unit 112, thermostat 114, refrigerator 116, and washer and dryer 118, that are configured to communicate with an access point 125 over an air interface 108 and/or a direct wired connection 109, a computer 120 that directly connects to the Internet 175 and/or connects to the Internet 175 through access point 125, and an IoT server 170 accessible via the Internet 175, etc.). As such, for brevity and ease of description, various details relating to certain components in the wireless communications system 100B shown in FIG. 1B may be omitted herein to the extent that the same or similar details have already been provided above in relation to the wireless communications system 100A illustrated in FIG. 1A.

Referring to FIG. 1B, the wireless communications system 100B may include a supervisor device 130, which may alternatively be referred to as an IoT manager 130 or IoT manager device 130. As such, where the following description uses the term “supervisor device” 130, those skilled in the art will appreciate that any references to an IoT manager, group owner, or similar terminology may refer to the supervisor device 130 or another physical or logical component that provides the same or substantially similar functionality.

In various embodiments, the supervisor device 130 may generally observe, monitor, control, or otherwise manage the various other components in the wireless communications system 100B. For example, the supervisor device 130 can communicate with an access network (e.g., access point 125) over air interface 108 and/or a direct wired connection 109 to monitor or manage attributes, activities, or other states associated with the various IoT devices 110-120 in the wireless communications system 100B. The supervisor device 130 may have a wired or wireless connection to the Internet 175 and optionally to the IoT server 170 (shown as a dotted line). The supervisor device 130 may obtain information from the Internet 175 and/or the IoT server 170 that can be used to further monitor or manage attributes, activities, or other states associated with the various IoT devices 110-120. The supervisor device 130 may be a standalone device or one of IoT devices 110-120, such as computer 120. The supervisor device 130 may be a physical device or a software application running on a physical device. The supervisor device 130 may include a user interface that can output information relating to the monitored attributes, activities, or other states associated with the IoT devices 110-120 and receive input information to control or otherwise manage the attributes, activities, or other states associated therewith. Accordingly, the supervisor device 130 may generally include various components and support various wired and wireless communication interfaces to observe, monitor, control, or otherwise manage the various components in the wireless communications system 100B.

The wireless communications system 100B shown in FIG. 1B may include one or more passive IoT devices 105 (in contrast to the active IoT devices 110-120) that can be coupled to or otherwise made part of the wireless communications system 100B. In general, the passive IoT devices 105 may include barcoded devices, Bluetooth devices, radio frequency (RF) devices, RFID tagged devices, infrared (IR) devices, NFC tagged devices, or any other suitable device that can provide an identifier and attributes associated therewith to another device when queried over a short range interface. Active IoT devices may detect, store, communicate, act on, and/or the like, changes in attributes of passive IoT devices.

For example, the one or more passive IoT devices 105 may include a coffee cup passive IoT device 105 and an orange juice container passive IoT device 105 that each have an RFID tag or barcode. A cabinet IoT device (not shown) and the refrigerator IoT device 116 may each have an appropriate scanner or reader that can read the RFID tag or barcode to detect when the coffee cup passive IoT device 105 and/or the orange juice container passive IoT device 105 have been added or removed. In response to the cabinet IoT device detecting the removal of the coffee cup passive IoT device 105 and the refrigerator IoT device 116 detecting the removal of the orange juice container passive IoT device 105, the supervisor device 130 may receive one or more signals that relate to the activities detected at the cabinet IoT device and the refrigerator IoT device 116. The supervisor device 130 may then infer that a user is drinking orange juice from the coffee cup passive IoT device 105 and/or likes to drink orange juice from the coffee cup passive IoT device 105.

Although the foregoing describes the passive IoT devices 105 as having some form of RFID tag or barcode communication interface, the passive IoT devices 105 may include one or more devices or other physical objects that do not have such communication capabilities. For example, certain IoT devices may have appropriate scanner or reader mechanisms that can detect shapes, sizes, colors, and/or other observable features associated with the passive IoT devices 105 to identify the passive IoT devices 105. In this manner, any suitable physical object may communicate an identity and one or more attributes associated therewith, become part of the wireless communications system 100B, and may be observed, monitored, controlled, or otherwise managed by the supervisor device 130. Further, passive IoT devices 105 may be coupled to or otherwise made part of the wireless communications system 100A in FIG. 1A and observed, monitored, controlled, or otherwise managed in a substantially similar manner.

In accordance with various aspects, FIG. 1C illustrates a high-level architecture of another wireless communications system 100C that contains a plurality of IoT devices. In general, the wireless communications system 100C shown in FIG. 1C may include various components that are the same and/or substantially similar to the wireless communications systems 100A and 100B shown in FIGS. 1A and 1B, respectively, which were described in greater detail above. As such, for brevity and ease of description, various details relating to certain components in the wireless communications system 100C shown in FIG. 1C may be omitted herein to the extent that the same or similar details have already been provided above in relation to the wireless communications systems 100A and 100B illustrated in FIGS. 1A and 1B, respectively.

The wireless communications system 100C shown in FIG. 1C illustrates exemplary peer-to-peer communications between the IoT devices 110-118 and the supervisor device 130. As shown in FIG. 1C, the supervisor device 130 communicates with each of the IoT devices 110-118 over an IoT supervisor interface. Further, IoT devices 110 and 114, IoT devices 112, 114, and 116, and IoT devices 116 and 118, communicate directly with each other.

The IoT devices 110-118 make up an IoT device group 160. The IoT device group 160 may comprise a group of locally connected IoT devices, such as the IoT devices connected to a user's home network. Although not shown, multiple IoT device groups may be connected to and/or communicate with each other via an IoT SuperAgent 140 connected to the Internet 175. At a high level, the supervisor device 130 manages intra-group communications, while the IoT SuperAgent 140 can manage inter-group communications. Although shown as separate devices, the supervisor device 130 and the IoT SuperAgent 140 may be, or reside on, the same device (e.g., a standalone device or an IoT device, such as computer 120 in FIG. 1A). Alternatively, the IoT SuperAgent 140 may correspond to or include the functionality of the access point 125. As yet another alternative, the IoT SuperAgent 140 may correspond to or include the functionality of an IoT server, such as IoT server 170. The IoT SuperAgent 140 may encapsulate gateway functionality 145.

Each IoT device 110-118 can treat the supervisor device 130 as a peer and transmit attribute/schema updates to the supervisor device 130. When an IoT device needs to communicate with another IoT device, the IoT device can request the pointer to that IoT device from the supervisor device 130 and then communicate with the target IoT device as a peer. The IoT devices 110-118 communicate with each other over a peer-to-peer communication network using a common messaging protocol (CMP). As long as two IoT devices are CMP-enabled and connected over a common communication transport, they can communicate with each other. In the protocol stack, the CMP layer 154 is below the application layer 152 and above the transport layer 156 and the physical layer 158.

In accordance with various aspects, FIG. 1D illustrates a high-level architecture of another wireless communications system 100D that contains a plurality of IoT devices. In general, the wireless communications system 100D shown in FIG. 1D may include various components that are the same and/or substantially similar to the wireless communications systems 100A-100C shown in FIGS. 1A-1C, respectively, which were described in greater detail above. As such, for brevity and ease of description, various details relating to certain components in the wireless communications system 100D shown in FIG. 1D may be omitted herein to the extent that the same or similar details have already been provided above in relation to the wireless communications systems 100A-100C illustrated in FIGS. 1A-1C, respectively.

The Internet 175 is a “resource” that can be regulated using the concept of the IoT. However, the Internet 175 is just one example of a resource that is regulated, and any resource could be regulated using the concept of the IoT. Other resources that can be regulated include, but are not limited to, electricity, gas, storage, security, and the like. An IoT device may be connected to the resource and thereby regulate the resource, or the resource could be regulated over the Internet 175. FIG. 1D illustrates several resources 180, such as natural gas, gasoline, hot water, and electricity, wherein the resources 180 can be regulated in addition to and/or over the Internet 175.

IoT devices can communicate with each other to regulate their use of a resource 180. For example, IoT devices such as a toaster, a computer, and a hairdryer may communicate with each other over a Bluetooth communication interface to regulate their use of electricity (the resource 180). As another example, IoT devices such as a desktop computer, a telephone, and a tablet computer may communicate over a Wi-Fi communication interface to regulate their access to the Internet 175 (the resource 180). As yet another example, IoT devices such as a stove, a clothes dryer, and a water heater may communicate over a Wi-Fi communication interface to regulate their use of gas. Alternatively, or additionally, each IoT device may be connected to an IoT server, such as IoT server 170, which has logic to regulate their use of the resource 180 based on information received from the IoT devices.

In accordance with various aspects, FIG. 1E illustrates a high-level architecture of another wireless communications system 100E that contains a plurality of IoT devices. In general, the wireless communications system 100E shown in FIG. 1E may include various components that are the same and/or substantially similar to the wireless communications systems 100A-100D shown in FIGS. 1A-1D, respectively, which were described in greater detail above. As such, for brevity and ease of description, various details relating to certain components in the wireless communications system 100E shown in FIG. 1E may be omitted herein to the extent that the same or similar details have already been provided above in relation to the wireless communications systems 100A-100D illustrated in FIGS. 1A-1D, respectively.

The wireless communications system 100E includes two IoT device groups 160A and 160B. Multiple IoT device groups may be connected to and/or communicate with each other via an IoT SuperAgent connected to the Internet 175. At a high level, an IoT SuperAgent may manage inter-group communications among IoT device groups. For example, in FIG. 1E, the IoT device group 160A includes IoT devices 116A, 122A, and 124A and an IoT SuperAgent 140A, while IoT device group 160B includes IoT devices 116B, 122B, and 124B and an IoT SuperAgent 140B. As such, the IoT SuperAgents 140A and 140B may connect to the Internet 175 and communicate with each other over the Internet 175 and/or communicate with each other directly to facilitate communication between the IoT device groups 160A and 160B. Furthermore, although FIG. 1E illustrates two IoT device groups 160A and 160B communicating with each other via IoT SuperAgents 140A and 140B, those skilled in the art will appreciate that any number of IoT device groups may suitably communicate with each other using IoT SuperAgents.

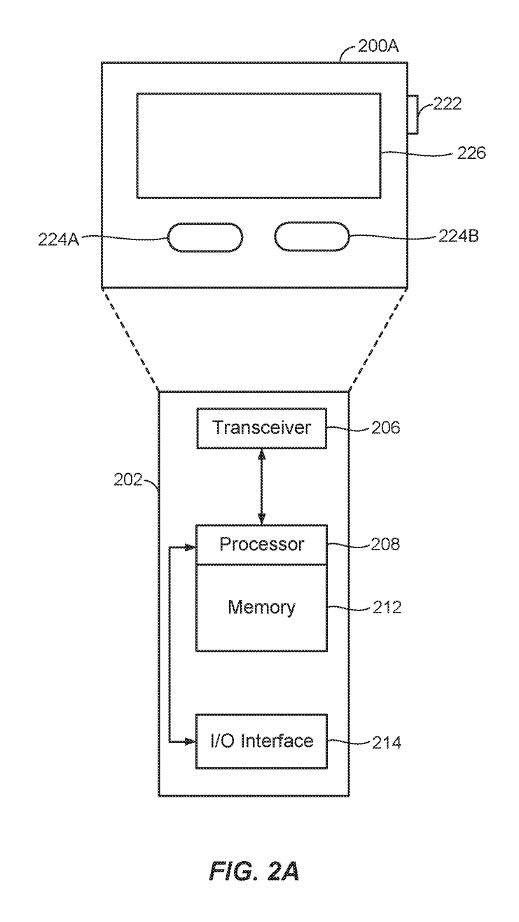

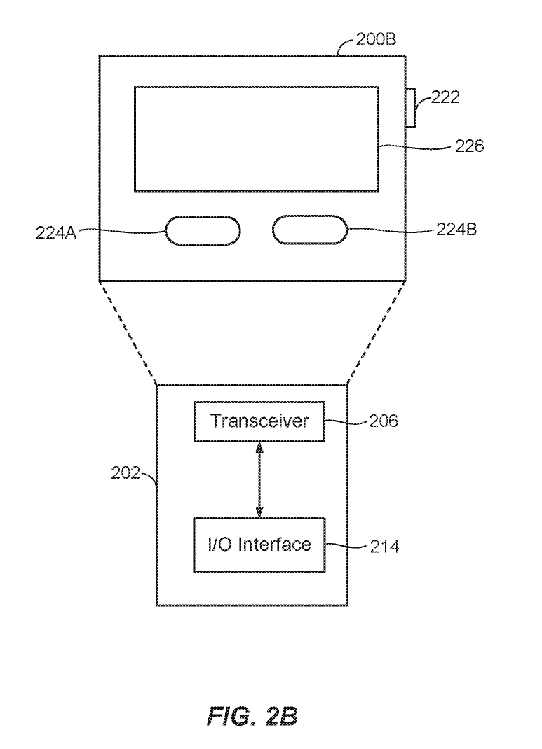

FIG. 2A illustrates a high-level example of an IoT device 200A in accordance with various aspects. While external appearances and/or internal components can differ significantly among IoT devices, most IoT devices will have some sort of user interface, which may comprise a display and a means for user input. IoT devices without a user interface can be communicated with remotely over a wired or wireless network, such as air interface 108 in FIGS. 1A-1B.

As shown in FIG. 2A, in an example configuration for the IoT device 200A, an external casing of IoT device 200A may be configured with a display 226, a power button 222, and two control buttons 224A and 224B, among other components, as is known in the art. The display 226 may be a touchscreen display, in which case the control buttons 224A and 224B may not be necessary. While not shown explicitly as part of IoT device 200A, the IoT device 200A may include one or more external antennas and/or one or more integrated antennas that are built into the external casing, including but not limited to Wi-Fi antennas, cellular antennas, satellite position system (SPS) antennas (e.g., global positioning system (GPS) antennas), and so on.

While internal components of IoT devices, such as IoT device 200A, can be embodied with different hardware configurations, a basic high-level configuration for internal hardware components is shown as platform 202 in FIG. 2A. The platform 202 can receive and execute software applications, data and/or commands transmitted over a network interface, such as air interface 108 in FIGS. 1A-1B and/or a wired interface. The platform 202 can also independently execute locally stored applications. The platform 202 can include one or more transceivers 206 configured for wired and/or wireless communication (e.g., a Wi-Fi transceiver, a Bluetooth transceiver, a cellular transceiver, a satellite transceiver, a GPS or SPS receiver, etc.) operably coupled to one or more processors 208, such as a microcontroller, microprocessor, application specific integrated circuit, digital signal processor (DSP), programmable logic circuit, or other data processing device, which will be generally referred to as processor 208. The processor 208 can execute application programming instructions within a memory 212 of the IoT device. The memory 212 can include one or more of read-only memory (ROM), random-access memory (RAM), electrically erasable programmable ROM (EEPROM), flash cards, or any memory common to computer platforms. One or more input/output (I/O) interfaces 214 can be configured to allow the processor 208 to communicate with and control from various I/O devices such as the display 226, power button 222, control buttons 224A and 224B as illustrated, and any other devices, such as sensors, actuators, relays, valves, switches, and the like associated with the IoT device 200A.

Accordingly, various aspects can include an IoT device (e.g., IoT device 200A) including the ability to perform the functions described herein. As will be appreciated by those skilled in the art, the various logic elements can be embodied in discrete elements, software modules executed on a processor (e.g., processor 208) or any combination of software and hardware to achieve the functionality disclosed herein. For example, transceiver 206, processor 208, memory 212, and I/O interface 214 may all be used cooperatively to load, store and execute the various functions disclosed herein and thus the logic to perform these functions may be distributed over various elements. Alternatively, the functionality could be incorporated into one discrete component. Therefore, the features of the IoT device 200A in FIG. 2A are to be considered merely illustrative and the IoT device 200A is not limited to the illustrated features or arrangement shown in FIG. 2A.

FIG. 2B illustrates a high-level example of a passive IoT device 200B in accordance with various aspects. In general, the passive IoT device 200B shown in FIG. 2B may include various components that are the same and/or substantially similar to the IoT device 200A shown in FIG. 2A, which was described in greater detail above. As such, for brevity and ease of description, various details relating to certain components in the passive IoT device 200B shown in FIG. 2B may be omitted herein to the extent that the same or similar details have already been provided above in relation to the IoT device 200A illustrated in FIG. 2A.

The passive IoT device 200B shown in FIG. 2B may generally differ from the IoT device 200A shown in FIG. 2A in that the passive IoT device 200B may not have a processor, internal memory, or certain other components. Instead, in various embodiments, the passive IoT device 200B may only include an I/O interface 214 or other suitable mechanism that allows the passive IoT device 200B to be observed, monitored, controlled, managed, or otherwise known within a controlled IoT network. For example, in various embodiments, the I/O interface 214 associated with the passive IoT device 200B may include a barcode, Bluetooth interface, radio frequency (RF) interface, RFID tag, IR interface, NFC interface, or any other suitable I/O interface that can provide an identifier and attributes associated with the passive IoT device 200B to another device when queried over a short range interface (e.g., an active IoT device, such as IoT device 200A, that can detect, store, communicate, act on, or otherwise process information relating to the attributes associated with the passive IoT device 200B).

Although the foregoing describes the passive IoT device 200B as having some form of RF, barcode, or other I/O interface 214, the passive IoT device 200B may comprise a device or other physical object that does not have such an I/O interface 214. For example, certain IoT devices may have appropriate scanner or reader mechanisms that can detect shapes, sizes, colors, and/or other observable features associated with the passive IoT device 200B to identify the passive IoT device 200B. In this manner, any suitable physical object may communicate an identity and one or more attributes associated therewith and be observed, monitored, controlled, or otherwise managed within a controlled IoT network.

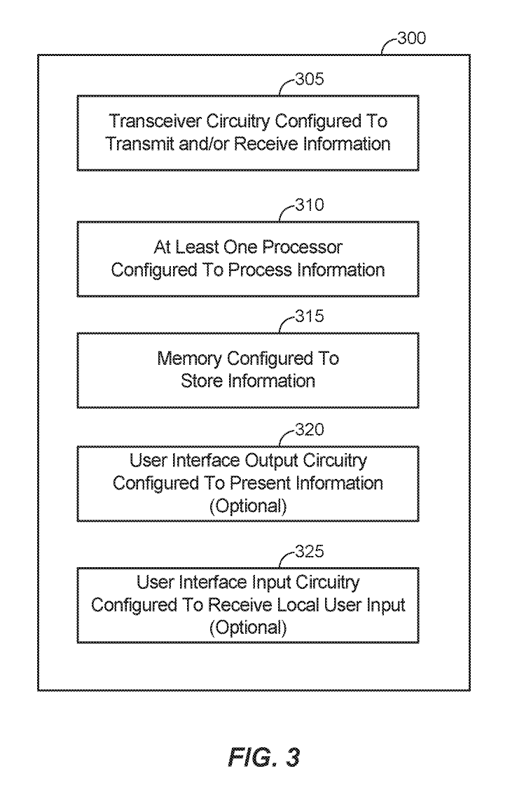

FIG. 3 illustrates a communication device 300 that includes various structural components configured to perform functionality. The communication device 300 can correspond to any of the communication devices described in further detail above, including but not limited to any one or more of the IoT devices or other devices in the wireless communications systems 100A-100E shown in FIGS. 1A-1E, the IoT device 200A shown in FIG. 2A, the passive IoT device 200B shown in FIG. 2B, any components coupled to the Internet 175 (e.g., the IoT server 170), and so on. Accordingly, those skilled in the art will appreciate that the communication device 300 shown in FIG. 3 can correspond to any electronic device configured to communicate with and/or facilitate communication with one or more other entities, such as in the wireless communications systems 100A-100E as shown in FIGS. 1A-1E.

Referring to FIG. 3, the communication device 300 includes transceiver circuitry configured to transmit and/or receive information 305. In an example, if the communication device 300 corresponds to a wireless communications device (e.g., IoT device 200A and/or passive IoT device 200B), the transceiver circuitry configured to transmit and/or receive information 305 can include a wireless communications interface (e.g., Bluetooth, Wi-Fi, Wi-Fi Direct, Long-Term Evolution (LTE) Direct, etc.) such as a wireless transceiver and associated hardware (e.g., an RF antenna, a MODEM, a modulator and/or demodulator, etc.). In another example, the transceiver circuitry configured to transmit and/or receive information 305 can correspond to a wired communications interface (e.g., a serial connection, a USB or Firewire connection, an Ethernet connection through which the Internet 175 can be accessed, etc.). Thus, if the communication device 300 corresponds to some type of network-based server (e.g., the IoT server 170), the transceiver circuitry configured to transmit and/or receive information 305 can correspond to an Ethernet card, in an example, that connects the network-based server to other communication entities via an Ethernet protocol. In a further example, the transceiver circuitry configured to transmit and/or receive information 305 can include sensory or measurement hardware by which the communication device 300 can monitor a local environment associated therewith (e.g., an accelerometer, a temperature sensor, a light sensor, an antenna for monitoring local RF signals, etc.). The transceiver circuitry configured to transmit and/or receive information 305 can also include software that, when executed, permits the associated hardware of the transceiver circuitry configured to transmit and/or receive information 305 to perform the reception and/or transmission function(s) associated therewith. However, the transceiver circuitry configured to transmit and/or receive information 305 does not correspond to software alone, and the transceiver circuitry configured to transmit and/or receive information 305 relies at least in part upon structural hardware to achieve the functionality associated therewith.

Referring to FIG. 3, the communication device 300 further includes at least one processor configured to process information 310. Example implementations of the type of processing that can be performed by the at least one processor configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. For example, the at least one processor configured to process information 310 can include a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the at least one processor configured to process information 310 may be any conventional processor, controller, microcontroller, or state machine. The at least one processor configured to process information 310 may also be implemented as a combination of computing devices (e.g., a combination of a DSP and a microprocessor, a plurality of microprocessors, one or more microprocessors in conjunction with a DSP core, or any other such configuration). The at least one processor configured to process information 310 can also include software that, when executed, permits the associated hardware of the at least one processor configured to process information 310 to perform the processing function(s) associated therewith. However, the at least one processor configured to process information 310 does not correspond to software alone, and the at least one processor configured to process information 310 relies at least in part upon structural hardware to achieve the functionality associated therewith.

Referring to FIG. 3, the communication device 300 further includes memory configured to store information 315. In an example, the memory configured to store information 315 can include at least a non-transitory memory and associated hardware (e.g., a memory controller, etc.). For example, the non-transitory memory included in the memory configured to store information 315 can correspond to RAM, flash memory, ROM, erasable programmable ROM (EPROM), EEPROM, registers, hard disk, a removable disk, a CD-ROM, or any other form of storage medium known in the art. The memory configured to store information 315 can also include software that, when executed, permits the associated hardware of the memory configured to store information 315 to perform the storage function(s) associated therewith. However, the memory configured to store information 315 does not correspond to software alone, and the memory configured to store information 315 relies at least in part upon structural hardware to achieve the functionality associated therewith.

Referring to FIG. 3, the communication device 300 further optionally includes user interface output circuitry configured to present information 320. In an example, the user interface output circuitry configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to the IoT device 200A as shown in FIG. 2A and/or the passive IoT device 200B as shown in FIG. 2B, the user interface output circuitry configured to present information 320 can include the display 226. In a further example, the user interface output circuitry configured to present information 320 can be omitted for certain communication devices, such as network communication devices that do not have a local user (e.g., network switches or routers, remote servers, etc.). The user interface output circuitry configured to present information 320 can also include software that, when executed, permits the associated hardware of the user interface output circuitry configured to present information 320 to perform the presentation function(s) associated therewith. However, the user interface output circuitry configured to present information 320 does not correspond to software alone, and the user interface output circuitry configured to present information 320 relies at least in part upon structural hardware to achieve the functionality associated therewith.

Referring to FIG. 3, the communication device 300 further optionally includes user interface input circuitry configured to receive local user input 325. In an example, the user interface input circuitry configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to the IoT device 200A as shown in FIG. 2A and/or the passive IoT device 200B as shown in FIG. 2B, the user interface input circuitry configured to receive local user input 325 can include the buttons 222, 224A, and 224B, the display 226 (if a touchscreen), etc. In a further example, the user interface input circuitry configured to receive local user input 325 can be omitted for certain communication devices, such as network communication devices that do not have a local user (e.g., network switches or routers, remote servers, etc.). The user interface input circuitry configured to receive local user input 325 can also include software that, when executed, permits the associated hardware of the user interface input circuitry configured to receive local user input 325 to perform the input reception function(s) associated therewith. However, the user interface input circuitry configured to receive local user input 325 does not correspond to software alone, and the user interface input circuitry configured to receive local user input 325 relies at least in part upon structural hardware to achieve the functionality associated therewith.

Referring to FIG. 3, while the structural components 305 through 325 are shown as separate or distinct blocks in FIG. 3, those skilled in the will appreciate that the various structural components 305 through 325 may be coupled to one other via an associated communication bus (not shown) and further that the hardware and/or software through which the respective structural components 305 through 325 perform the respective functionality associated therewith can overlap in part. For example, any software used to facilitate the functionality associated with the structural components 305 through 325 can be stored in the non-transitory memory associated with the memory configured to store information 315, such that the configured structural components 305 through 325 each perform the respective functionality associated therewith (i.e., in this case, software execution) based in part upon the operation of the software stored in the memory configured to store information 315. Likewise, hardware that is directly associated with one of the structural components 305 through 325 can be borrowed or used by other structural components 305 through 325 from time to time. For example, the at least one processor configured to process information 310 can format data into an appropriate format before being transmitted via the transceiver circuitry configured to transmit and/or receive information 305, such that the transceiver circuitry configured to transmit and/or receive information 305 performs the functionality associated therewith (i.e., in this case, transmission of data) based in part upon the operation of structural hardware associated with the at least one processor configured to process information 310.

Accordingly, those skilled in the art will appreciate that the various structural components 305 through 325 as shown in FIG. 3 are intended to invoke an aspect that is at least partially implemented with structural hardware, and are not intended to map to software-only implementations that are independent of hardware and/or non-structural (e.g., purely functional) interpretations. Furthermore, those skilled in the art will appreciate other interactions or cooperation between the structural components 305 through 325, which will become clear based on the various aspects and embodiments described more fully below.

Certain IoT devices are deployed with firmware that controls general device functions and which changes infrequently. However, there are times when firmware updates are required for various reasons, such as enabling new features, fixing bugs in older firmware versions, maintaining compatibility with various communication protocols or other standards, improving various efficiencies of operation (e.g., improving a heart-rate monitor algorithm, etc.), assigning new security patches or updating a network key, and so on. These IoT devices can remain in active communication with the IoT network to check for firmware updates, but this can be a power-consuming process (particularly for battery-powered IoT devices) and the IoT communications interface used by the IoT network may not be sufficiently secure for transferring a firmware update. An alternative to using the IoT network to update the firmware on an IoT device is for a user to manually update the firmware via direct interaction with the IoT device, but manually installing firmware updates may be tedious and may not be possible for IoT devices installed in hard to reach locations (e.g., behind walls, etc.). Collecting diagnostic information from IoT devices can also be a power-consuming process, and manually collecting such diagnostic information may be difficult for IoT devices installed in hard to reach locations.

Embodiments of the disclosure are thereby directed to updating firmware on an IoT device and/or exchanging diagnostic information with the IoT device while a control device provides wireless power to the IoT device via a magnetic coupling between the IoT device and the control device. The wireless power from the control device is used to help power a short-range wireless communications interface of the IoT device. The short-range wireless communications interface that is powered at least in part by the wireless power from the control device is then used to transfer the firmware update and/or the diagnostic information over a short-range wireless communications connection between the control device and the IoT device.

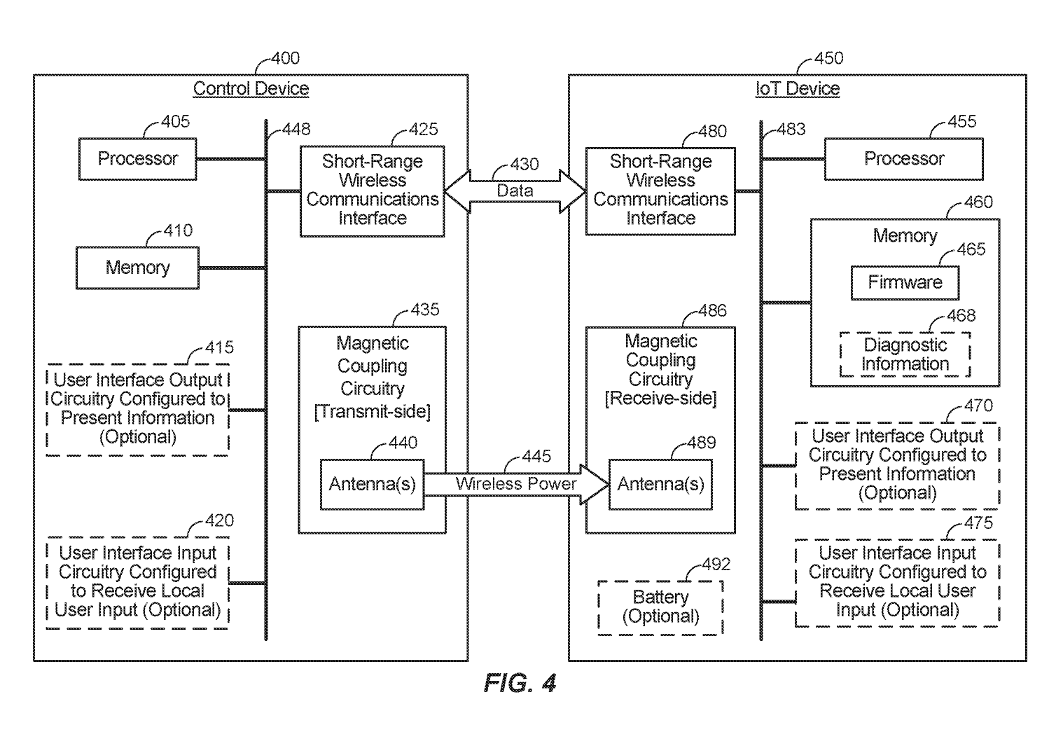

FIG. 4 illustrates a control device 400 that is magnetically coupled to an IoT device 450 in accordance with an embodiment of the disclosure. Referring to FIG. 4, the control device 400 includes a processor 405 and a memory 410. The control device 400 further optionally includes user interface output circuitry 415 configured to present information (e.g., corresponding to 320 of FIG. 3) and/or user interface input circuitry 420 configured to receive local user input (e.g., corresponding to 325 of FIG. 3). The control device 400 further includes a short-range wireless communications interface 425 that is configured to exchange data 430 with one or more external devices, such as the IoT device 450. The short-range wireless communications interface 425 can be configured to support a short-range wireless communications connection with one or more external devices in accordance with any well-known short-range wireless communications protocols, including but not limited to a magnetic induction-based communications protocol, Near-Field Communication (NFC), Bluetooth, low-power Wi-Fi, ZigBee/802.15.4 and so on. Components 405-425 of FIG. 4 may be coupled together at the control device 400 via a bus 448. The control device 400 further includes magnetic coupling circuitry 435 with at least one antenna 440 that is configured to send wireless power 445 to one or more external devices, such as the IoT device 450, via a magnetic coupling. In an example, the magnetic coupling circuitry 435 can conform to any of a plurality of well-known magnetic induction-based wireless charging technologies, such as NFC Initiator (or NFC Forum), Rezence or Airfuel Alliance power transmitter unit (PTU), or Qi charger (or Wireless Power Consortium).

Referring to FIG. 4, the IoT device 450 includes a processor 455 and a memory 460. The memory 460 stores firmware 465 that is configured to be executed by the processor 455 to facilitate the general functionality of the IoT device 450. The IoT device 450 optionally stores diagnostic information 468. The diagnostic information 468 can include various records of various health or performance metrics associated with the IoT device 450, including but not limited to a battery level of the IoT device 450, a time log indicating when the IoT device 450 functioned normally and when the IoT device 450 functioned abnormally (e.g., when the IoT device 450 experienced problems such as being offline from the IoT network, losing power, sensor errors, and so on). The diagnostic information 468 is optional data and is not expressly required for operation of the IoT device 450. Moreover, the diagnostic information 468 may include diagnostic information that is collected while the IoT device 450 is powered via magnetic-induction in at least one embodiment (in contrast to an historical time log that logs diagnostic data over time) as will be described below.

The IoT device 450 further optionally includes user interface output circuitry 470 configured to present information (e.g., corresponding to 320 of FIG. 3) and/or user interface input circuitry 475 configured to receive local user input (e.g., corresponding to 325 of FIG. 3). The IoT device 450 further includes a short-range wireless communications interface 480 that is configured to exchange data 430 with one or more external devices, such as the control device 400. The short-range wireless communications interface 480 can be configured to support a short-range wireless communications connection with one or more external devices in accordance with any well-known short-range wireless communications protocols, including but not limited to a magnetic induction-based communications protocol, NFC, Bluetooth, low-power Wi-Fi, ZigBee/802.15.4 and so on. Components 455-480 of FIG. 4 may be coupled together at the IoT device 450 via a bus 483. The IoT device 450 further includes magnetic coupling circuitry 486 with at least one antenna 489 that is configured to receive wireless power 445 from one or more external devices, such as the control device 400, via a magnetic coupling. In an example, the magnetic coupling circuitry 486 can conform to any well-known magnetic induction-based wireless charging technology, such as NFC Initiator (or NFC Forum), Rezence or Airfuel Alliance PTU, or Qi charger (or Wireless Power Consortium). The IoT device 450 further optionally includes a battery 492. As will be explained below in more detail, if the battery 492 is included (e.g., as opposed to a wired power source), the battery 492 may be charged at least in part via the wireless power 445.

Referring to FIG. 4, in at least one embodiment the control device 400 may be implemented as a mobile communications device (e.g., a smart-phone, a tablet computer, etc.). Further, the IoT device 450 can correspond to any type of IoT device, including but not limited to a beacon (e.g., smart keyfob, etc.), a human interface device (HID) (e.g., a keyboard, a mouse, etc.), smart gear (e.g., a pedometer, a Fitbit, etc.), a smart home device (e.g., a motion sensor, a door controller, an environmental monitoring sensor, an HVAC control sensor, a remote control for an appliance such as a set-top box or receiver, a light controller, a set-top box, a security or alarm sensor, a window controller, etc.), a health monitor (e.g., a heart-rate monitor, etc.) and so on.

Referring to FIG. 4, in another example, if the IoT device 450 is implemented as a non-rechargeable battery-powered device, the IoT device 450 may be expected to last several months or even years without a change to the battery. If the non-rechargeable battery-powered device does not have a wired port (e.g., a wearable IoT device that is configured for wireless charging only without a typical wired charging port such as a USB port) or its wired port is inaccessible (e.g., device is installed behind a wall, attached to a ceiling, etc.), the non-rechargeable battery-powered device will be reliant upon wireless communication for firmware updates and/or exchanges of diagnostic information, which can drain power. Powering the short-range wireless communications interface 480 using some of the wireless power 445 is one way to implement firmware updates and/or exchanges of diagnostic information for these types of IoT devices by mitigating the power drain problem.

In at least one embodiment of the disclosure, different types of magnetic coupling circuitries (e.g., Airfuel Alliance PTU, Qi charger or Wireless Power Consortium, NFC Initiator or NFC Forum, etc.) can be associated with different wireless coupling ranges and/or with different power transfer capacities. Accordingly, the type of short-range wireless communications interface 480 that is powered by the wireless power 445 may be based in part upon the type of magnetic coupling circuitries 435/486 that are used to transfer the wireless power 445. Table 1 (below) shows a few examples of the suitable magnetic coupling circuitry types for powering particular short-range wireless communication interface types:

TABLE 1
Examples Of Suitable Magnetic Coupling Circuitry Types For
Powering Particular Short-Range Wireless Communication Interface Types

| Magnetic Coupling | Short-Range Wireless |
|---|---|
| Circuitry Type | Communication Interface Type |
| NFC Initiator | NFC P2P |
| NFC Initiator | Bluetooth |
| NFC Initiator | Magnetic Induction |
| NFC Initiator | Low-Power WiFi |
| Airfuel Alliance PTU | Bluetooth |
| Airfuel Alliance PTU | Magnetic Induction |
| Airfuel Alliance PTU | Low-Power WiFi |
| Qi Charger | Bluetooth |
| Qi Charger | Magnetic Induction |
| Qi Charger | Low-Power WiFi |

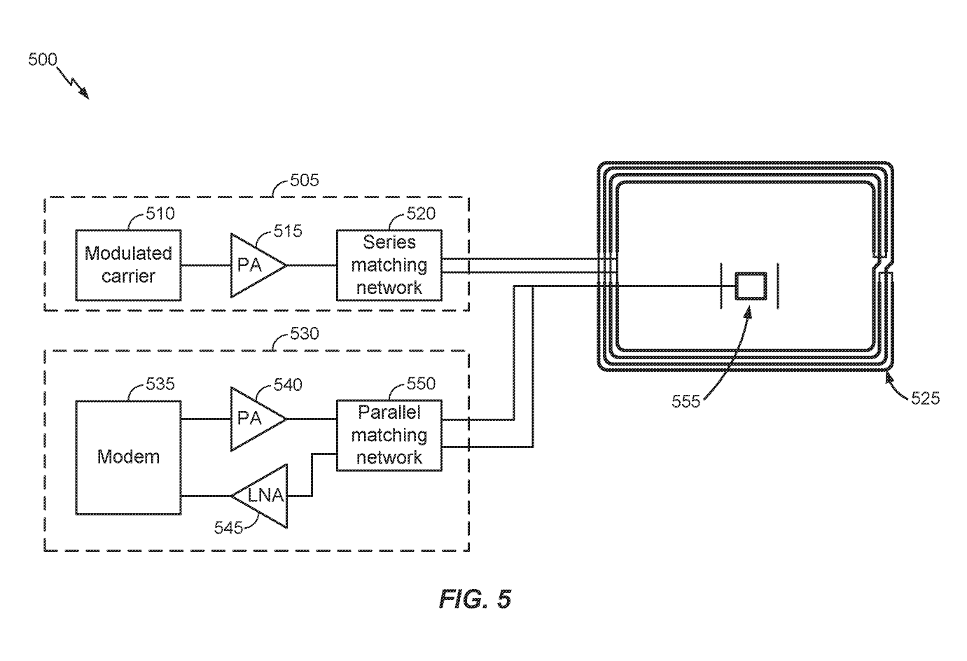

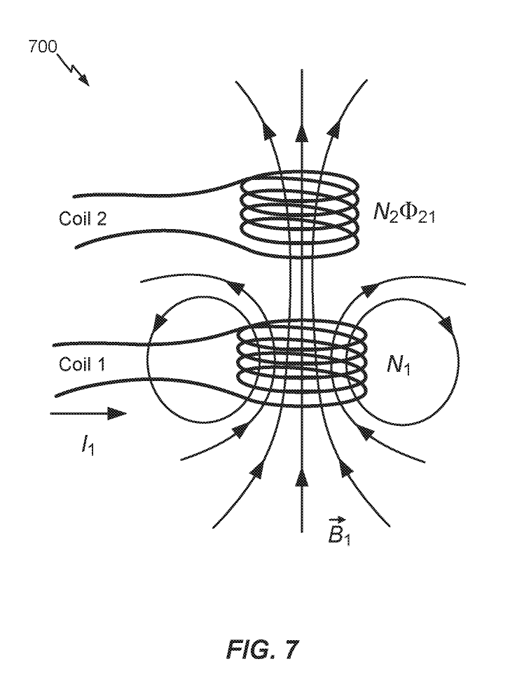

FIG. 5 illustrates an antenna configuration 500 at the control device 400 in accordance with an embodiment of the disclosure. The antenna configuration 500 includes magnetic coupling circuitry components 505 which include a modulated carrier circuit 510, a power amplifier (PA) 515 and a series matching network circuit 520. The series matching network circuit 520 is coupled to a charging antenna array 525 which includes one or more charging antennas. The charging antenna array 525 may correspond to the at least one antenna 440 depicted in FIG. 4. The series matching network circuit 520 applies electric power to magnetic coils (not shown) of the charging antenna array 525 which are configured to induce a magnetic field so as to transmit wireless power that can be received by another proximate antenna array at a target device, as will be discussed in more detail below with respect to FIG. 7.

Referring to FIG. 5, the antenna configuration 500 at the control device 400 further includes communication components 530, which include a modem 535, a PA 540, a low noise amplifier (LNA) 545 and a parallel matching network circuit 550. The parallel matching network circuit 550 exchanges data with a communication antenna 555 that wirelessly transmits and receives data in accordance with any well-known wireless communications protocol, including but not limited to a magnetic induction-based communications protocol, NFC, Bluetooth, low-power Wi-Fi, ZigBee/802.15.4 and so on. In an example, the communication components 530 and communication antenna 555 may collectively correspond to the short-range wireless communications interface 425 of the control device 400 as described above with respect to FIG. 4.

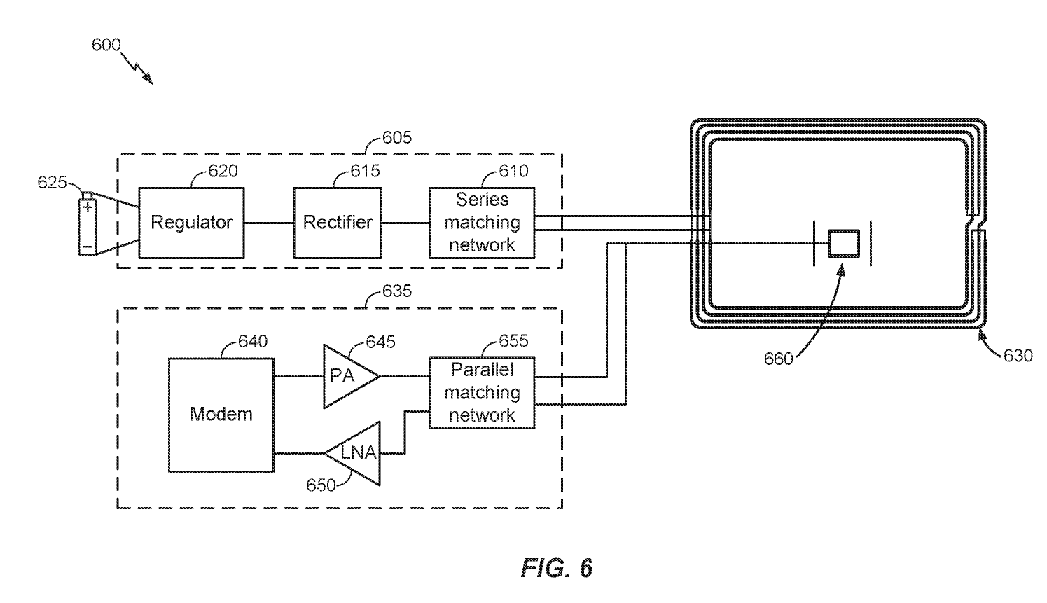

FIG. 6 illustrates an antenna configuration 600 at the IoT device 450 in accordance with an embodiment of the disclosure. The antenna configuration 600 includes magnetic coupling circuitry components 605 which include a series matching network circuit 610, a rectifier 615 and a regulator 620. The regulator 620 outputs electric power that can be used to power a battery 625 or alternatively can be used to directly power various components of the IoT device 450. The series matching network circuit 610 is coupled to a charging antenna array 630 which includes one or more charging antennas. The charging antenna array 630 may correspond to the at least one antenna 489 depicted in FIG. 4. The series matching network circuit 610 receives electric power via magnetic coils (not shown) of the charging antenna array 630 which is generated from a magnetic field at a proximate source device, as will be discussed in more detail below with respect to FIG. 7.

Referring to FIG. 6, the antenna configuration 600 at the IoT device 450 further includes the communication components 635 which include a modem 640, a PA 645, an LNA 650 and a parallel matching network circuit 655. The parallel matching network circuit 655 exchanges data with a communication antenna 660 that wirelessly transmits and receives data in accordance with any well-known wireless communications protocol, including but not limited to a magnetic induction-based communications protocol, NFC, Bluetooth, low-power Wi-Fi, ZigBee/802.15.4 and so on. In an example, the communication components 635 and communication antenna 660 may collectively correspond to the short-range wireless communications interface 480 of the IoT device 450 as described above with respect to FIG. 4.

FIG. 7 illustrates a magnetic induction-based power exchange system 700 whereby power is exchanged between two coils in accordance with an embodiment of the disclosure. Referring to FIG. 7, coil 1 generates a changing magnetic field. A voltage is generated at the terminals of coil 2 that is placed within the changing magnetic field. Coil 1 is the transmit antenna and coil 2 is the receive antenna. The detected voltage across coil 2 is an indication of the localized field strength at coil 2. The load across coil 2 is made large to avoid loading coil 1 and is a restriction related to magnetic induction-based power transfer. The power transmission range is proportional to antenna sizes and coupling factors. A relatively low amount of power is dissipated compared with typical electromagnetic (EM) systems. In context with FIG. 4, coil 1 of FIG. 7 corresponds to the at least one antenna 440 and coil 2 of FIG. 7 corresponds to the at least one antenna 489.

FIG. 8 illustrates operation of a control device in accordance with an embodiment of the disclosure. Referring to FIG. 8, the control device transmits wireless power to an IoT device via a magnetic coupling between at least one antenna of the IoT device and a magnetic field that is generated by the control device, 800. The control device communicates with a short-range wireless communications interface of the IoT device (e.g., over a short-range wireless communications connection) to transfer a firmware update to the IoT device and/or receive diagnostic information from the IoT device, wherein the short-range wireless communications interface of the IoT device is powered at least in part by the wireless power and the communication occurs while the magnetic field continues to provide the wireless power to the IoT device via the magnetic coupling, 805. In an example, the control device described above with respect to FIG. 8 may correspond to the control device 400 of FIG. 4, while the IoT device described above with respect to FIG. 8 may correspond to the IoT device 450 of FIG. 4.

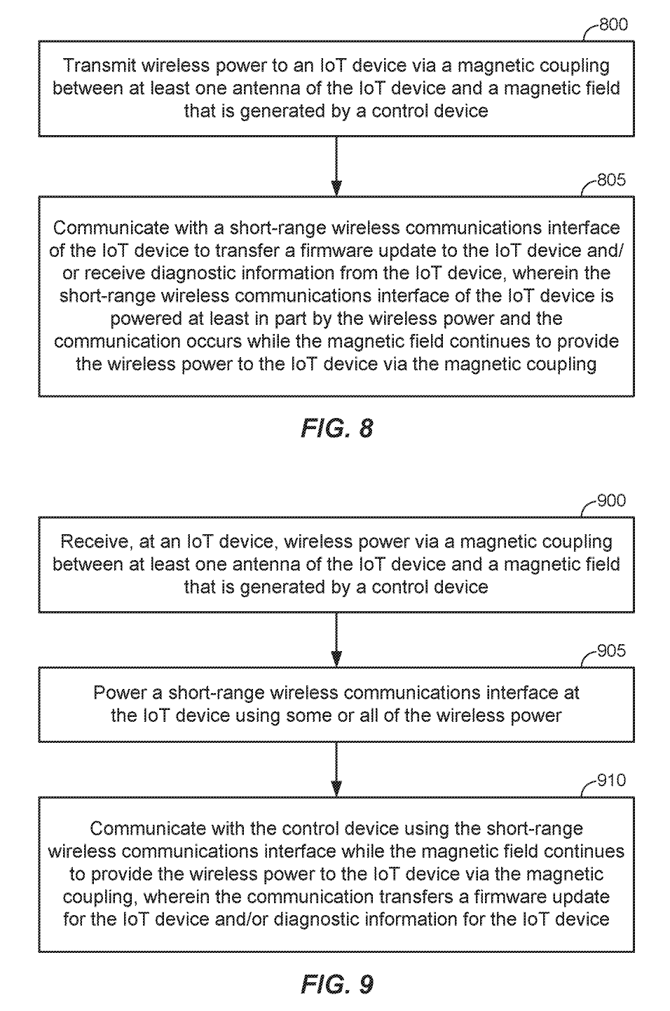

FIG. 9 illustrates operation of an IoT device in accordance with an embodiment of the disclosure. Referring to FIG. 9, the IoT device receives wireless power via a magnetic coupling between at least one antenna of the IoT device and a magnetic field that is generated by a control device, 900. The IoT device powers a short-range wireless communications interface at the IoT device using some or all of the wireless power, 905. The IoT device communicates with the control device using the short-range wireless communications interface (e.g., via a short-range wireless communications connection) while the magnetic field continues to provide the wireless power to the IoT device via the magnetic coupling, 910. The communication of 910 is used to transfer a firmware update for updating firmware stored on the IoT device and/or to transfer diagnostic information for the IoT device. In an example, the control device described above with respect to FIG. 9 may correspond to the control device 400 of FIG. 4, while the IoT device described above with respect to FIG. 9 may correspond to the IoT device 450 of FIG. 4.

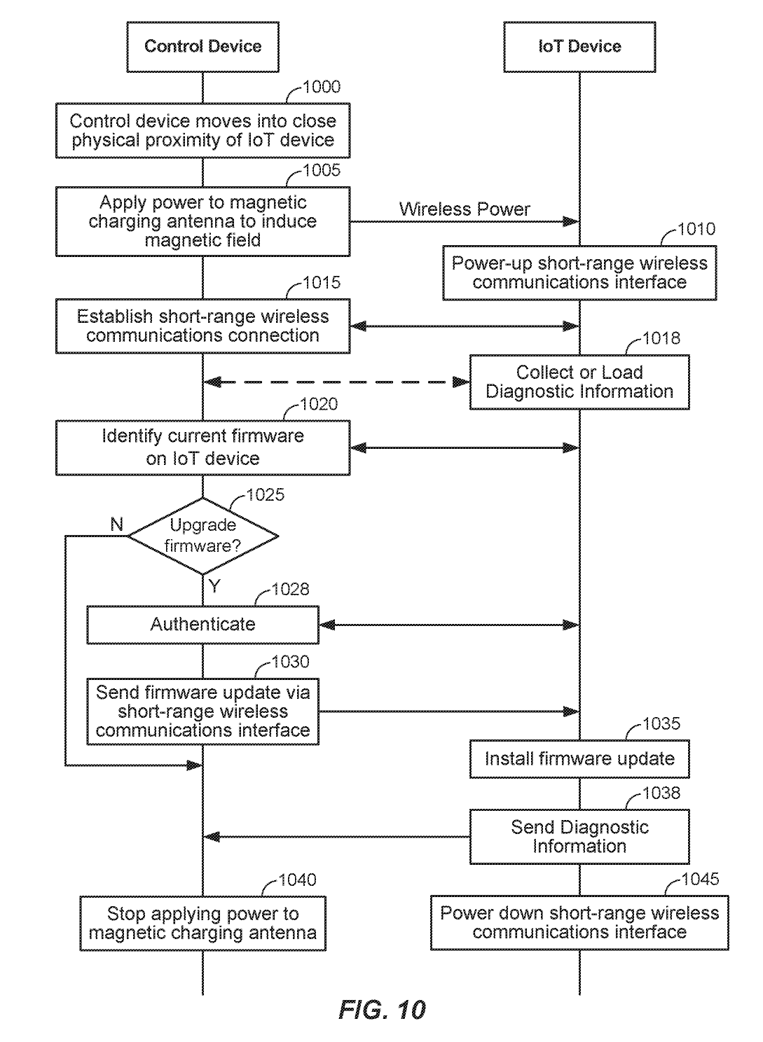

FIG. 10 illustrates an example implementation of the processes of FIGS. 8-9 in accordance with an embodiment of the disclosure. Referring to FIG. 10, the control device moves into close physical proximity of the IoT device, 1000. For example, at 1000, the control device may move inside of a communication range of the short-range wireless communications interfaces 425 and 480 and inside of a power transmission range of the magnetic coupling circuitries 435 and 486 with respect to the IoT device. The control device applies power to at least one magnetic charging antenna (e.g., antenna(s) 440 of FIG. 4) to induce a changing magnetic field that provides wireless power to the IoT device (e.g., via corresponding magnetic charging antenna(s) at the IoT device), 1005 (e.g., as in 800 of FIG. 8 or 900 of FIG. 9). The IoT device receives the wireless power from 1005 and uses some or all of the received wireless power to power-up a short-range wireless communications interface, 1010 (e.g., as in 905 of FIG. 9). In an example of 1010, the received wireless power can be used to charge a battery of the IoT device, with the battery providing power to the short-range wireless communications interface. In an alternative example of 1010, the received wireless power can be directly applied to the short-range wireless communications interface. In another alternative example of 1010, some of the received wireless power can be directly applied to the short-range wireless communications interface while other of the received wireless power is applied elsewhere (e.g., to charge the battery, etc.). In another alternative example of 1010, some or all of the received wireless power can be applied to the short-range wireless communications interface while being supplemented with power from another power source, such as the battery.

Referring to FIG. 10, after the short-range wireless communications interface is powered up at the IoT device, a short-range wireless communications connection is established between the control device and the IoT device, 1015. At 1018, the IoT device collects or loads diagnostic information that characterizes one or more operational parameters of the IoT device (e.g., a battery level of the IoT device, an historical time log indicating when the IoT device functioned normally and abnormally prior to receiving the wireless power, diagnostic data collected by the IoT device during the receiving, a combination thereof, etc.). In an example, some or all of the diagnostic information is collected automatically in response the wireless power being received at 1005. Alternatively, the IoT device may already have collected some or all of the diagnostic information prior to the wireless power being received at 1005 (e.g., using a battery or other power source), and this pre-collected diagnostic information can simply be loaded from memory at 1018. Further, diagnostic software that is executed at the IoT device to collect and/or load the diagnostic information can either be maintained internally at the IoT device (e.g., as part of the Basic Input/Output System (BIOS), etc.), or alternatively the diagnostic software can be transferred over the short-range wireless communications connection 1015.

Referring to FIG. 10, the control device interacts with the IoT device over the short-range wireless communications connection to identify a current firmware version installed on the IoT device, 1020. Based on the firmware version identification of 1020, the control device determines to upgrade the firmware on the IoT device, 1025. For example, at 1025, the control device may compare the identified firmware version from 1020 with a current version of the firmware, with the control device determining to upgrade the firmware on the IoT device if the comparison indicates a difference.

Referring to FIG. 10, if the control device determines not to upgrade the firmware on the IoT device at 1025, the process advances to 1040. Otherwise, if the control device determines to upgrade the firmware on the IoT device at 1025, the control device authenticates itself as having sufficient privileges for updating the firmware on the IoT device, 1028. The authentication at 1028 ensures that an unauthorized third party cannot simply walk up to any IoT device with an unauthorized control device and change its firmware, although the authentication requirement of 1028 can be disabled by an operator of the IoT device if security is not desired. The control device sends a firmware update to the IoT device via the short-range wireless communications interface, 1030 (e.g., as in 805 of FIG. 8 or 910 of FIG. 9). Once the firmware update has been transferred at 1030, the IoT device installs the firmware update (assuming the control device is properly authenticated at 1028), 1035 (e.g., as in 915 of FIG. 9). Also, once the diagnostic software completes execution, some or all of the diagnostic information is sent to the control device via the short-range wireless communications connection at 1038. While not shown explicitly in FIG. 10, the diagnostic information for the IoT device that is sent at 1038 may be stored on the control device, transmitted to a different device, displayed to an operator of the control device or any combination thereof.

Once the firmware update has been transferred at 1030 (or alternatively once the IoT device provides an acknowledgement to the control device that the firmware update has successfully installed at 1035) and the diagnostic information is exchanged at 1038, the control device stops applying power to the magnetic charging antenna(s), 1040, and the IoT device powers down its short-range wireless communications interface, 1045. In an example, the authentication at 1028 may trigger the firmware update transfer at 1030, or alternatively the firmware update may be transferred irrespective of authentication status with the IoT device requiring authentication prior to installation of the firmware update at 1035. In a further example, the authentication at 1028 may trigger the diagnostic information exchange at 1038, or alternatively the diagnostic information may be transferred irrespective of authentication status. While FIG. 10 illustrates an implementation whereby both diagnostic information and a firmware update are exchanged between the control device and the IoT device, it will be appreciated that other embodiments can be directed to a firmware update without a diagnostic information exchange and/or to a diagnostic information exchange without the firmware update.

As will be appreciated from a review of FIGS. 4-10, close-proximity magnetically-induced wireless power can be transferred from the control device to the IoT device to facilitate a firmware update and/or diagnostic information exchange procedure. These embodiments can facilitate more secure firmware updates and/or diagnostic information exchanges by virtue of the close-proximity required for magnetic power transfer, can be used to update firmware and/or diagnostic information for hard-to-reach IoT devices (e.g., sensors hidden behind walls, etc.) and/or can be used to reduce power consumption of the IoT device in association with performing firmware updates and/or diagnostic information exchanges.

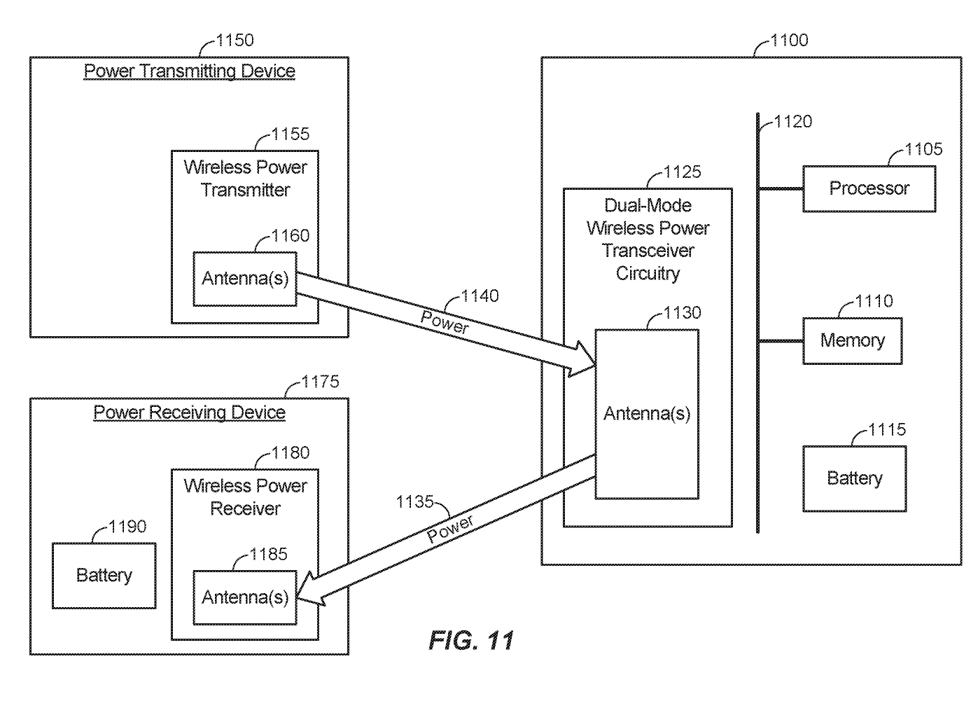

While the embodiments of FIGS. 4-10 relate to magnetically-induced wireless power in context with a firmware update and/or diagnostic information procedure, other embodiments of the disclosure are directed to implementing a dual-mode (or two-way) wireless power exchange capability (magnetic or otherwise) at a device, as will now be described with respect to FIGS. 11-13.

FIG. 11 illustrates a dual-mode wireless power transfer device 1100 that is configured to connect to a power transmitting device 1150 and a power receiving device 1175 in accordance with an embodiment of the disclosure. Referring to FIG. 11, the dual-mode wireless power transfer device 1100 includes a processor 1105, a memory 1110 and a battery 1115. The processor 1105 and memory 1110 are connected via a bus 1120. While not illustrated explicitly, the dual-mode wireless power transfer device 1100 may optionally include user interface output circuitry configured to present information (e.g., corresponding to 320 of FIG. 3), user interface input circuitry configured to receive local user input (e.g., corresponding to 325 of FIG. 3), short or long-range wireless communications interfaces, and so on. In one example, the dual-mode wireless power transfer device 1100 may be implemented as a smart-phone or tablet computer.

Referring to FIG. 11, the dual-mode wireless power transfer device 1100 further includes dual-mode wireless power transceiver circuitry 1125 with at least one antenna 1130 that is configured to both send wireless power 1135 to the power receiving device 1175 (e.g., the IoT device 450) and further to receive wireless power 1140 from the power transmitting device 1150 (e.g., a wireless charging hub).

Referring to FIG. 11, the power transmitting device 1150 includes a wireless power transmitter 1155 with at least one antenna 1160 that is configured to transmit the wireless power 1140, and the power receiving device 1175 includes a wireless power receiver 1180 with at least one antenna 1185 that is configured to receive the wireless power 1135, which can be used to charge a battery 1190 or directly power other components (not shown) of the power receiving device 1175.

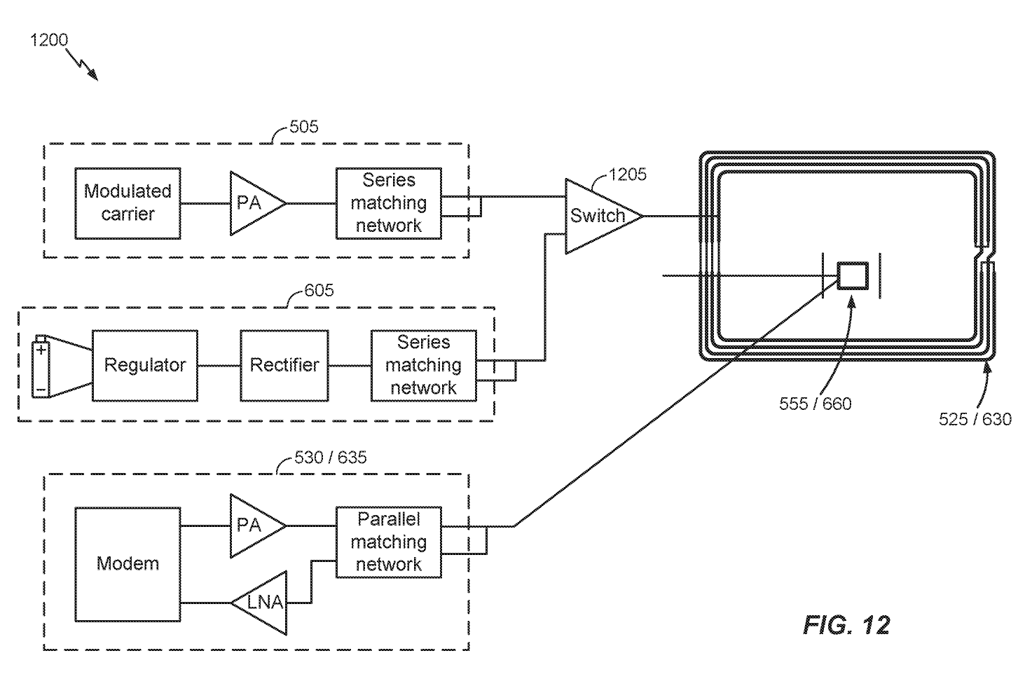

Unlike the embodiments described above with respect to FIGS. 4-10, the wireless power 1135-1140 exchanged via the dual-mode wireless power transceiver circuitry 1125 need not be based on magnetic coupling, although this is certainly one possible implementation which is described below in more detail with respect to FIG. 12. In an example, the dual-mode wireless power transceiver circuitry 1125 may execute in either a receive-power mode or a transmit-power mode, such that power cannot be wirelessly transmitted and received concurrently at the dual-mode wireless power transceiver circuitry 1125. As described below, this allows the hardware requirements of the dual-mode wireless power transceiver circuitry 1125 to be lower because the same antenna(s) 1130 can be re-used for both modes of operation. However, it is also possible for separate antennas to be deployed to facilitate concurrent execution of the receive-power mode and transmit-power mode, although this will increase the cost of the dual-mode wireless power transceiver circuitry 1125.

FIG. 12 illustrates an antenna configuration 1200 at the dual-mode wireless power transfer device 1100 in accordance with an embodiment of the disclosure. The embodiment of FIG. 12 depicts a wireless transfer implementation based on magnetic coupling, although the dual-mode wireless power transfer device 1100 of FIG. 11 is not restricted to magnet coupling-based wireless transfer technologies.

Referring to FIG. 12, the magnetic coupling circuitry components 505 of FIG. 5 and the magnetic coupling circuitry components 605 of FIG. 6 are both deployed as part of the antenna configuration 1200, with each set of components being connected to a switch 1205. The switch 1205 controls whether the dual-mode wireless power transceiver circuitry 1125 of FIG. 11 is configured for receive-power mode or transmit-power mode. In particular, the switch 1205 being configured to select the magnetic coupling circuitry components 505 puts the dual-mode wireless power transceiver circuitry 1125 into transmit-power mode, whereas the switch 1205 being configured to select the magnetic coupling circuitry components 605 puts the dual-mode wireless power transceiver circuitry 1125 into receive-power mode. The antenna configuration 1200 further includes communication components 530/635, charging antenna array 525/630 and communication antenna 555/660, which are unchanged from their respective descriptions above with respect to FIGS. 5-6.

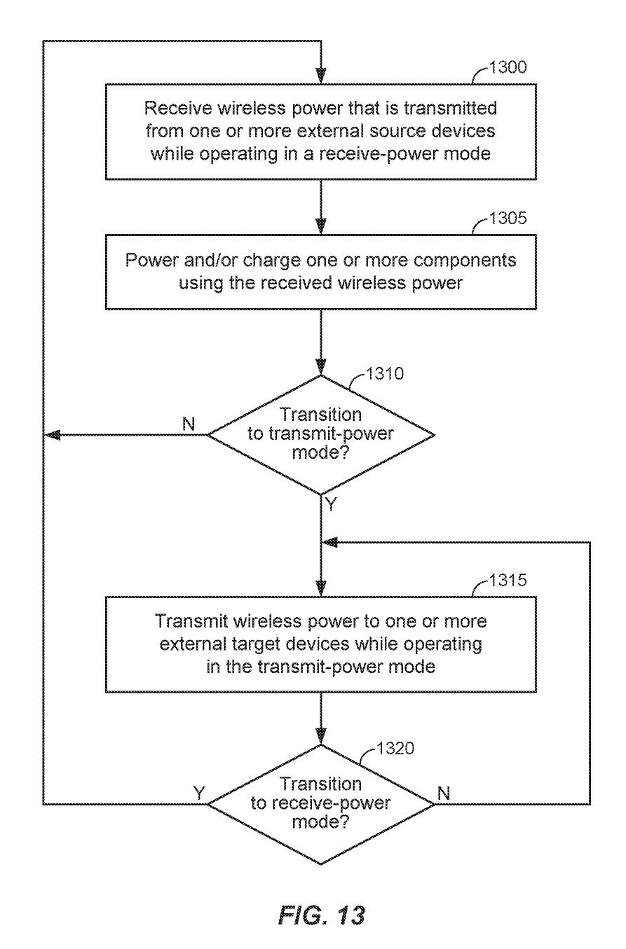

FIG. 13 illustrates a process whereby the dual-mode wireless power transfer device 1100 switches between the receive-power mode and the transmit-power mode in accordance with an embodiment of the disclosure. Referring to FIG. 13, the dual-mode wireless power transfer device 1100 receives wireless power that is transmitted from one or more external source devices (e.g., power transmitting device 1150) while operating in the receive-power mode, 1300. The dual-mode wireless power transfer device 1100 powers and/or charges one or more components (e.g., battery 1115, etc.) using the received wireless power, 1305. In doing so, the dual-mode wireless power transfer device 1100 can therefore daisy-chain the distribution of power throughout a set of closely located IoT devices (e.g., to help power the set of IoT devices for the purpose of a system-wide diagnostic test, a system-wide firmware update, a system-wide battery charge, etc.).

Referring to FIG. 13, the dual-mode wireless power transfer device 1100 determines whether to transition from the receive-power mode to the transmit-power mode, 1310. If the dual-mode wireless power transfer device 1100 determines not to transition from the receive-power mode to the transmit-power mode at 1310, the process returns to 1300 (or alternatively the process simply terminates if the receive-power mode is no longer required). Otherwise, if the dual-mode wireless power transfer device 1100 determines to transition from the receive-power mode to the transmit-power mode at 1310, the dual-mode wireless power transfer device 1100 transmits wireless power to one or more external target devices (e.g., power receiving device 1175) while operating in the transmit-power mode, 1315.

Referring to FIG. 13, the dual-mode wireless power transfer device 1100 determines whether to transition from the transmit-power mode back to the receive-power mode, 1320. If the dual-mode wireless power transfer device 1100 determines not to transition from the transmit-power mode back to the receive-power mode at 1320, the process returns to 1315 (or alternatively the process simply terminates if the transmit-power mode is no longer required). Otherwise, if the dual-mode wireless power transfer device 1100 determines to transition from the transmit-power mode back to the receive-power mode at 1320, the process returns to 1300. While the process of FIG. 13 is described with respect to the dual-mode wireless power transfer device 1100 starting in receive-power mode, it will be appreciated that the process of FIG. 13 could also be initiated at 1315 with the dual-mode wireless power transfer device 1100 beginning in transmit-power mode.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. The functions, steps and/or actions of the method claims in accordance with the aspects and embodiments described herein need not be performed in any particular order. Furthermore, although elements may be described above or claimed in the singular, the plural is contemplated unless limitation to the singular is explicitly stated.

What is claimed is:

1. A method of operating a control device that is configured to communicate with an Internet of Things (IoT) device that is connected to an IoT network, comprising:
transmitting, at the control device, wireless power to the IoT device via a magnetic coupling between at least one antenna of the IoT device and a magnetic field that is generated by the control device; and
communicating with a short-range wireless communications interface of the IoT device to transfer a firmware update to the IoT device and/or to receive diagnostic information from the IoT device, wherein the short-range wireless communications interface of the IoT device is powered at least in part by the wireless power and the communicating occurs while the magnetic field continues to provide the wireless power to the IoT device via the magnetic coupling.

2. The method of claim 1, wherein the magnetic coupling is based on an Airfuel Alliance power transmitter unit (PTU) technology, a Near-Field Communication (NFC) Initiator or NFC Forum technology, or a Qi charger or Wireless Power Consortium technology.

3. The method of claim 1, wherein the communicating is over a short-range wireless communications connection which comprises a Near-Field Communication (NFC) connection, a Bluetooth connection, a low-power WiFi connection, a ZigBee/802.15.4 connection or a magnetic induction-based connection.

4. The method of claim 1, wherein the control device is a smart phone.

5. The method of claim 1, wherein the communicating transfers the firmware update.

6. The method of claim 5, further comprising:
authenticating, with the IoT device, the control device as having sufficient privileges for authorizing an update to firmware on the IoT device.

7. The method of claim 1, wherein the communicating receives the diagnostic information from the IoT device.

8. The method of claim 7, wherein the diagnostic information indicates one or more of:
a battery level of the IoT device,
an historical time log indicating when the IoT device functioned normally and abnormally prior to the transmitting,
diagnostic data collected by the IoT device during the transmitting, or
any combination thereof.

9. A method of operating an Internet of Things (IoT) device that is connected to an IoT network and is configured to communicate with a control device, comprising:
receiving, at the IoT device, wireless power via a magnetic coupling between at least one antenna of the IoT device and a magnetic field that is generated by the control device;
powering a short-range wireless communications interface at the IoT device using some or all of the wireless power;
communicating with the control device using the short-range wireless communications interface while the magnetic field continues to provide the wireless power to the IoT device via the magnetic coupling,
wherein the communicating transfers a firmware update for the IoT device and/or diagnostic information for the IoT device.

10. The method of claim 9, wherein the magnetic coupling is based on an Airfuel Alliance power transmitter unit (PTU) technology, a Near-Field Communication (NFC) Initiator or NFC Forum technology, or a Qi charger or Wireless Power Consortium technology.

11. The method of claim 9, wherein the communicating is over a short-range wireless communications connection which comprises a Near-Field Communication (NFC) connection, a Bluetooth connection, a low-power WiFi connection, a ZigBee/802.15.4 connection or a magnetic-induction-based connection.

12. The method of claim 9, wherein the IoT device includes a battery power source.

13. The method of claim 12, wherein the powering powers the short-range wireless communications interface based in part on power drawn from the battery power source.

14. The method of claim 9,
wherein the wireless power is applied to a battery, and the powering powers the short-range wireless communications interface using power drawn from the battery, or
wherein the wireless power is applied directly to the short-range wireless communications interface.

15. The method of claim 9, wherein the communicating transfers the firmware update.

16. The method of claim 15, further comprising:
authenticating the control device as having sufficient privileges for authorizing an update to firmware on the IoT device; and
installing the firmware update in response to the authenticating.

17. The method of claim 9, wherein the communicating transfers the diagnostic information.

18. The method of claim 17, wherein the diagnostic information indicates one or more of:
a battery level of the IoT device,
an historical time log indicating when the IoT device functioned normally and abnormally prior to the receiving,
diagnostic data collected by the IoT device during the receiving, or
any combination thereof.

19. A control device that is configured to communicate with an Internet of Things (IoT) device that is connected to an IoT network, comprising:
means for transmitting wireless power to the IoT device via a magnetic coupling between at least one antenna of the IoT device and a magnetic field that is generated by the control device; and
means for communicating with a short-range wireless communications interface of the IoT device to transfer a firmware update to the IoT device and/or to receive diagnostic information from the IoT device, wherein the short-range wireless communications interface of the IoT device is powered at least in part by the wireless power and the communication occurs while the magnetic field continues to provide the wireless power to the IoT device via the magnetic coupling.

20. The control device of claim 19, wherein the magnetic coupling is based on an Airfuel Alliance power transmitter unit (PTU) technology, a Near-Field Communication (NFC) Initiator or NFC Forum technology, or a Qi charger or Wireless Power Consortium technology.

21. The control device of claim 19, wherein the means for communicating communicates over a short-range wireless communications connection which comprises a Near-Field Communication (NFC) connection, a Bluetooth connection, a low-power WiFi connection, a ZigBee/802.15.4 connection or a magnetic induction-based connection.

22. The control device of claim 19, wherein the means for communicating transfers the firmware update.

23. The control device of claim 22, further comprising:
means for authenticating, with the IoT device, the control device as having sufficient privileges for authorizing an update to firmware on the IoT device.

24. The control device of claim 19, wherein the means for communicating receives the diagnostic information from the IoT device.

25. The control device of claim 24, wherein the diagnostic information indicates one or more of:
a battery level of the IoT device,
an historical time log indicating when the IoT device functioned normally and abnormally prior to the transmission of the wireless power,
diagnostic data collected by the IoT device during the transmission of the wireless power, or
any combination thereof.

26. An Internet of Things (IoT) device that is connected to an IoT network and is configured to communicate with a control device, comprising:
means for receiving wireless power via a magnetic coupling between at least one antenna of the IoT device and a magnetic field that is generated by the control device;
means for powering a means for communicating with the control device using some or all of the wireless power;
the means for communicating with the control device while the magnetic field continues to provide the wireless power to the IoT device via the magnetic coupling,
wherein the means for communicating transfers a firmware update for the IoT device and/or diagnostic information for the IoT device.

27. The IoT device of claim 26, wherein the magnetic coupling is based on an Airfuel Alliance power transmitter unit (PTU) technology, a Near-Field Communication (NFC) Initiator or NFC Forum technology, or a Qi charger or Wireless Power Consortium technology.

28. The IoT device of claim 26, wherein the means for communicating communicates over a short-range wireless communications connection which comprises a Near-Field Communication (NFC) connection, a Bluetooth connection, a low-power WiFi connection, a ZigBee/802.15.4 connection or a magnetic-induction-based connection.

29. The IoT device of claim 26,
wherein the wireless power is applied to a battery, and the means for powering powers the means for communicating using power drawn from the battery, or
wherein the wireless power is applied directly to the means for communicating.

30. The IoT device of claim 26, wherein the means for communicating transfers the firmware update.

31. The IoT device of claim 30, further comprising:
means for authenticating the control device as having sufficient privileges for authorizing an update to firmware on the IoT device; and
means for installing the firmware update in response to the authentication.

32. The IoT device of claim 26, wherein the means for communicating transfers the diagnostic information.

33. The IoT device of claim 32, wherein the diagnostic information indicates one or more of:
a battery level of the IoT device,
an historical time log indicating when the IoT device functioned normally and abnormally prior to the receiving,
diagnostic data collected by the IoT device during the receiving, or
any combination thereof.

34. A control device that is configured to communicate with an Internet of Things (IoT) device that is connected to an IoT network, comprising:
transceiver circuitry configured to transmit wireless power to the IoT device via a magnetic coupling between at least one antenna of the IoT device and a magnetic field that is generated by the control device and further configured to communicate with a short-range wireless communications interface of the IoT device to transfer a firmware update to the IoT device and/or to receive diagnostic information from the IoT device, wherein the short-range wireless communications interface of the IoT device is powered at least in part by the wireless power and the communication occurs while the magnetic field continues to provide the wireless power to the IoT device via the magnetic coupling.

35. The control device of claim 34, wherein the magnetic coupling is based on an Airfuel Alliance power transmitter unit (PTU) technology, a Near-Field Communication (NFC) Initiator or NFC Forum technology, or a Qi charger or Wireless Power Consortium technology.

36. The control device of claim 34, wherein the communication is over a short-range wireless communications connection which comprises a Near-Field Communication (NFC) connection, a Bluetooth connection, a low-power WiFi connection, a ZigBee/802.15.4 connection or a magnetic induction-based connection.

37. The control device of claim 34, wherein the transceiver circuitry transfers the firmware update.

38. The control device of claim 37, wherein the transceiver circuitry authenticates, with the IoT device, the control device as having sufficient privileges for authorizing an update to firmware on the IoT device.

39. The control device of claim 34, wherein the transceiver circuitry receives the diagnostic information from the IoT device.

40. The control device of claim 39, wherein the diagnostic information indicates one or more of:
a battery level of the IoT device,
an historical time log indicating when the IoT device functioned normally and abnormally prior to the transmission of the wireless power,
diagnostic data collected by the IoT device during the transmission of the wireless power, or
any combination thereof.

41. An Internet of Things (IoT) device that is connected to an IoT network and is configured to communicate with a control device, comprising:
transceiver circuitry configured to receive wireless power via a magnetic coupling between at least one antenna of the IoT device and a magnetic field that is generated by the control device;
a short-range wireless communications interface configured to be powered using some or all of the wireless power and to communicate with the control device while the magnetic field continues to provide the wireless power to the IoT device via the magnetic coupling,
wherein the short-range wireless communications interface transfers a firmware update for the IoT device and/or diagnostic information for the IoT device.

42. The IoT device of claim 41, wherein the magnetic coupling is based on an Airfuel Alliance power transmitter unit (PTU) technology, a Near-Field Communication (NFC) Initiator or NFC Forum technology, or a Qi charger or Wireless Power Consortium technology.

43. The IoT device of claim 41, wherein the communication is over a short-range wireless communications connection which comprises a Near-Field Communication (NFC) connection, a Bluetooth connection, a low-power WiFi connection, a ZigBee/802.15.4 connection or a magnetic-induction-based connection.

44. The IoT device of claim 41,
wherein the wireless power is applied to a battery, and short-range wireless communications interface receives power drawn from the battery, or
wherein the wireless power is applied directly to the short-range wireless communications interface.

45. The IoT device of claim 41, wherein the short-range wireless communications interface transfers the firmware update.

46. The IoT device of claim 45, further comprising:
at least one processor configured to authenticate the control device as having sufficient privileges for authorizing an update to firmware on the IoT device, and to install the firmware update in response to the authentication.

47. The IoT device of claim 41, wherein the short-range wireless communications interface transfers the diagnostic information.

48. The IoT device of claim 47, wherein the diagnostic information indicates one or more of:
a battery level of the IoT device,
an historical time log indicating when the IoT device functioned normally and abnormally prior to the receiving,
diagnostic data collected by the IoT device during the receiving, or
any combination thereof.

49. A non-transitory computer-readable medium containing instructions stored thereon, which, when executed by a control device that is configured to communicate with an Internet of Things (IoT) device that is connected to an IoT network, cause the control device to perform operations, the instructions including: comprising:
at least one instruction configured to cause the control device to transmit wireless power to the IoT device via a magnetic coupling between at least one antenna of the IoT device and a magnetic field that is generated by the control device; and
at least one instruction configured to cause the control device to communicate with a short-range wireless communications interface of the IoT device to transfer a firmware update to the IoT device and/or to receive diagnostic information from the IoT device, wherein the short-range wireless communications interface of the IoT device is powered at least in part by the wireless power and the communication occurs while the magnetic field continues to provide the wireless power to the IoT device via the magnetic coupling.

50. A non-transitory computer-readable medium containing instructions stored thereon, which, when executed by an Internet of Things (IoT) device that is connected to an IoT network and is configured to communicate with a control device, cause the IoT device to perform operations, the instructions including: comprising:
at least one instruction configured to cause the IoT device to receive wireless power via a magnetic coupling between at least one antenna of the IoT device and a magnetic field that is generated by the control device;
at least one instruction configured to cause the IoT device to power a short-range wireless communications interface using some or all of the wireless power;
at least one instruction configured to cause the IoT device to communicate with the control device while the magnetic field continues to provide the wireless power to the IoT device via the magnetic coupling,
wherein the communication transfers a firmware update for the IoT device and/or diagnostic information for the IoT device.

51. A dual-mode wireless power transfer device, comprising:
dual-mode wireless power transceiver circuitry including at least one antenna and a switch that is configured to switch the dual-mode wireless power transceiver circuitry between a receive-power mode and a transmit-power mode,
wherein, when operating in the receive-power mode, the at least one antenna is configured to receive wireless power that is transmitted from one or more power transmitting devices and used to power and/or charge one or more components on the dual-mode wireless power transfer device, and
wherein, when operating in the transmit-power mode, the at least one antenna is configured to wirelessly transmit power to one or more power receiving devices to power and/or charge one or more components on the one or more power receiving devices.

52. The dual-mode wireless power transfer device of claim 51, wherein the dual-mode wireless power transceiver circuitry is configured to receive the wireless power in the receive-power mode in accordance with a magnetic coupling-based wireless power transfer scheme.

53. A method of operating a dual-mode wireless power transfer device, comprising:
selectively executing either a receive-power mode or a transmit-power mode,
wherein the receive-power mode is characterized by the dual-mode wireless power transfer device receiving wireless power that is transmitted from one or more power transmitting devices and used to power and/or charge one or more components on the dual-mode wireless power transfer device, and
wherein the transmit-power mode is characterized by the dual-mode wireless power transfer device transmitting wireless power to one or more power receiving devices to power and/or charge one or more components on the one or more power receiving devices.

54. The method of claim 53, further comprising:
switching between the receive-power mode and the transmit-power mode.
